(19) United States
(12) Patent Application Publication
(10) Pub. No.: US 2008/0258643 A1
(43) Pub. Date: Oct. 23, 2008

(54) Method for driving alternate current of light emitting diode and operating voltage thereof

(75) Inventors: Ying-Chang CHENG, Taipei Hsien (TW); Shih-Hung LIU, Taipei Hsien (TW)

Correspondence Address: Joe McKinney Muncy, PO Box 1364, Fairfax, VA, 22038-1364, US

(73) Assignee: Zippy Technology Corp.

(21) Appl. No.: 11/902,592

(22) Filed: Sep. 24, 2007

(30) Foreign Application Priority Data
Apr. 21, 2007 (BA) TW-M310296-U

(51) Int. Cl. H05B 41/16

(52) U.S. Cl. 315/246

(57) ABSTRACT

A method for driving AC of light emitting diodes includes an AC obtaining measure for obtaining an AC sine wave signal having positive and negative half-cycle waveforms; a power modulation measure for modulating the AC sine wave signal and an impedance of first and second LED groups according to at least two opposite conducting directions connected in parallel to change the positive half-cycle waveform to comply with an operation range of the positive half-cycle driving signal of the first LED group and modulate the negative half-cycle waveform to comply with an operation range of the negative half-cycle driving signal of the second LED group; and a power driving measure for driving the first and second LED groups by the positive and negative half-cycle driving signals, and the first and second LED groups are driven sequentially according to the operating cycles of the positive and negative half-cycle driving signals respectively.

### FIELD OF THE INVENTION

The present invention relates to a driving method and its operating voltage, and more particularly to a method for driving an alternate current of a light emitting diode and its operating voltage.

### BACKGROUND OF THE INVENTION

Since ultra high brightness light emitting diode (UHB LED) is introduced to the market, and white light LED technology tends to be increasingly well-developed, products applied to table lamps and projectors are developed gradually. The era of LED illumination has arrived, and LEDs can even replace present incandescent tungsten-filament bulbs, and thus becoming a main light source for indoor illuminations. In general, a traditional LED driving circuit is provided for converting AC signals of utility power into DC to drive a light emitting diode (LED), but the conversion process consumes much electric power, so that a circuit for driving an LED directly by an AC signal is developed. FIG. 1 shows a circuit driven by a plurality of LEDs connected in parallel, and FIG. 2 shows a circuit of a circuit driven by a plurality of LEDs connected in series. An LED lamp module disclosed in R.O.C. Pat. No. M310296 comprises: a plug, having a circuit board therein, for converting AC power into DC power; an LED lamp string, connected to the plug for receiving the DC power, and composed of a plurality of LEDs which are connected in series and controlled by the circuit board. The circuit captures a half-cycle wave of the AC signal to drive the LEDs connected in series or parallel. Since the aforementioned circuit just captures a half-cycle wave of the AC signal to drive a plurality of LEDs, the power used for the remaining unused half-cycle wave is wasted. In addition, the total impedance of the foregoing plurality of LEDs is very low, and a certain quantity of LEDs is needed to improve the total impedance if the LEDs are driven directly by utility power. This arrangement can prevent damages caused by the operating voltage of utility power that exceeds its operation range, and thus the AC driving mode of LEDs is limited by the input power and the operation range of the LEDs. Therefore, finding a way of improving the aforementioned issue of driving an AC of the LEDs becomes a major subject for related manufacturers.

### SUMMARY OF THE INVENTION

It is the primary objective of the invention to provide an AC driving mode for LEDs with a flexible design.

To achieve the foregoing objective, the present invention provides a method for driving an alternate current of a light emitting diode, and the method comprises: an AC obtaining measure for obtaining an AC sine wave signal having positive and negative half-cycle waveforms; a power modulation measure for modulating an impedance of first and second LED groups according to at least two conducting directions that are in opposite directions with each other and connected in parallel, and an AC sine wave signal of the AC obtaining measure to change the positive half-cycle waveform of the AC sine wave signal to comply with an operation range of the positive half-cycle driving signal of the first LED group, and the negative half-cycle waveform of the AC sine wave signal to comply with an operation range of the negative half-cycle driving signal of the second LED group; and a power driving measure, for driving the first LED group by the positive half-cycle driving signal of the power modulation measure and driving the second LED group by the negative half-cycle driving signal, wherein the first and second LED groups are driven sequentially according to operating cycles of the positive and negative half-cycle driving signals.

Another objective of the present invention is to modulate an input power by using an auto load function of a piezoelectric inverter to comply with an operation range of the LEDs in the first and second LED groups and drive the power of the first and second LED groups.

To achieve the foregoing objective, the present invention uses a piezoelectric inverter for the aforementioned power modulation measure.

A further objective of the present invention is to modulate AC power to drive an LED directly according to an operation range of the LED.

To achieve the foregoing objective, the present invention provides an AC operating voltage of an LED, characterized in that the LED includes at least two conducting directions which are in opposite directions with each other, and first and second LED groups connected in parallel, and changes a positive half-cycle waveform of an AC sine wave signal to comply with an operation range of a positive half-cycle driving signal of the first LED group for driving the first LED group, and modulates a negative half-cycle waveform of the AC sine wave signal to comply with an operation range of negative half-cycle driving signals of the second LED group for driving the second LED group, wherein the first and second LED groups are driven sequentially according to operating cycles of the positive and negative half-cycle driving signals.

### BRIEF DESCRIPTION OF THE DRAWINGS

FIG. 1 is a schematic circuit diagram of a prior art;

FIG. 2 is a schematic circuit diagram of another prior art;

FIG. 3 is a schematic circuit diagram of a preferred embodiment of the present invention;

FIG. 4 is a schematic waveform diagram of an AC sine wave signal in accordance with a preferred embodiment of the present invention;

FIG. 5 is a schematic waveform diagram of an AC modulated sine wave signal in accordance with a preferred embodiment of the present invention; and

FIG. 6 is a schematic waveform diagram of electrically conducted first and second LED groups in accordance with a preferred embodiment of the present invention.

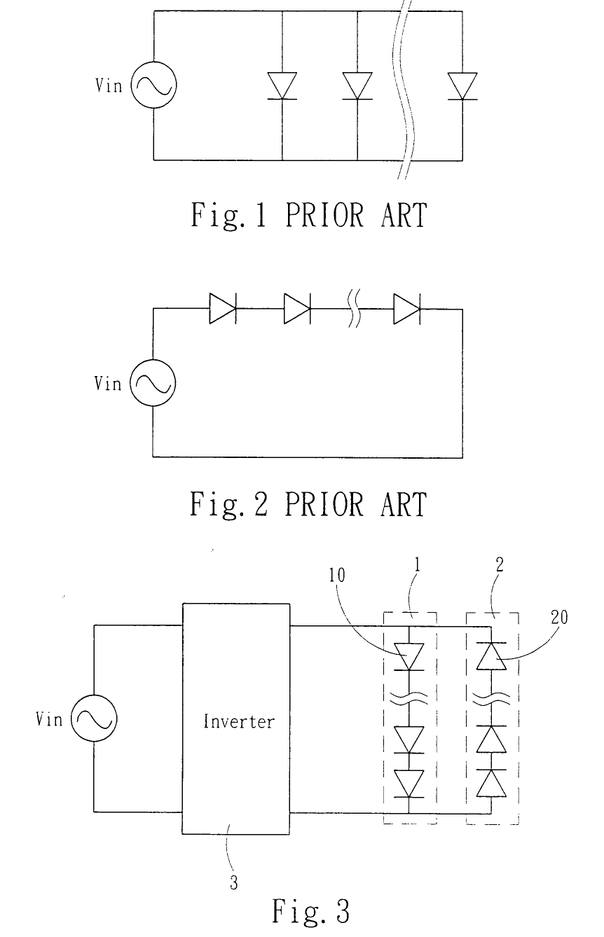

### DETAILED DESCRIPTION OF THE PREFERRED EMBODIMENTS

The present invention will now be described in more detail hereinafter with reference to the accompanying drawings that show various embodiments of the invention.

Referring to FIG. 3 for a schematic circuit diagram of a preferred embodiment of the present invention, the technical measures taken by a method for driving an alternate current of a light emitting diode in accordance with the present invention are described as follows:

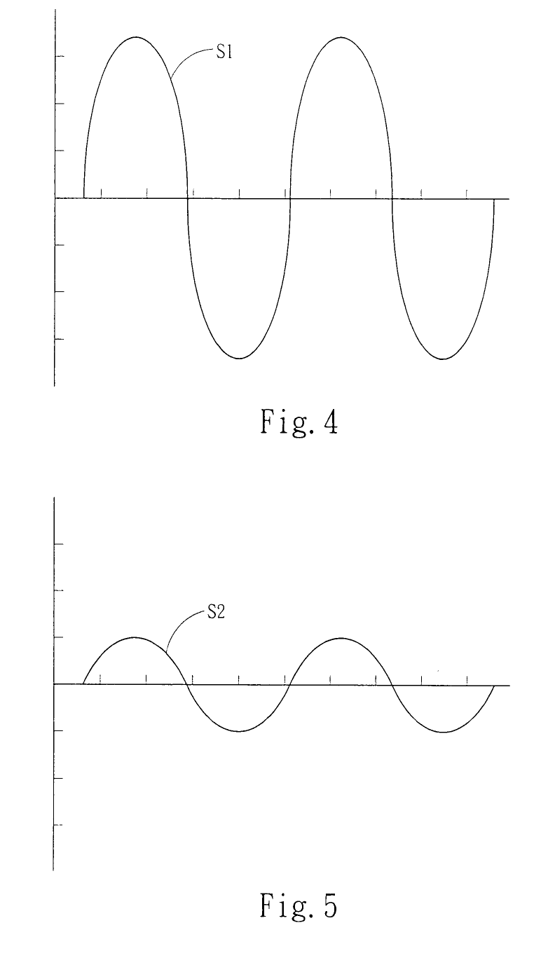

In an AC obtaining measure, an external power supply Vin is connected to obtain an AC sine wave signal S1 having positive and negative half-cycle waveforms (as shown in FIG. 4), wherein the AC is assumed to be 110 volt with a frequency of 60 Hz. In other words, the minimum voltage is 0 volt, and the maximum voltage is approximately 155 volts.

In an LED group setting measure, first and second LED groups 1, 2 are installed with at least two opposite conducting directions and connected in parallel, and each LED group 1, 2 is composed of a plurality of LEDs 10, 20 connected in series and having the same conducting direction, such that the conducting direction of all LEDs 10 in the first LED group 1 is opposite to the conducting direction of all LEDs 20 in the second LED group 2. To facilitate the impedance matching, each LED group 1, 2 includes an even number of LEDs, and the operation range and brightness of each LED 10, 20 are set to be the same.

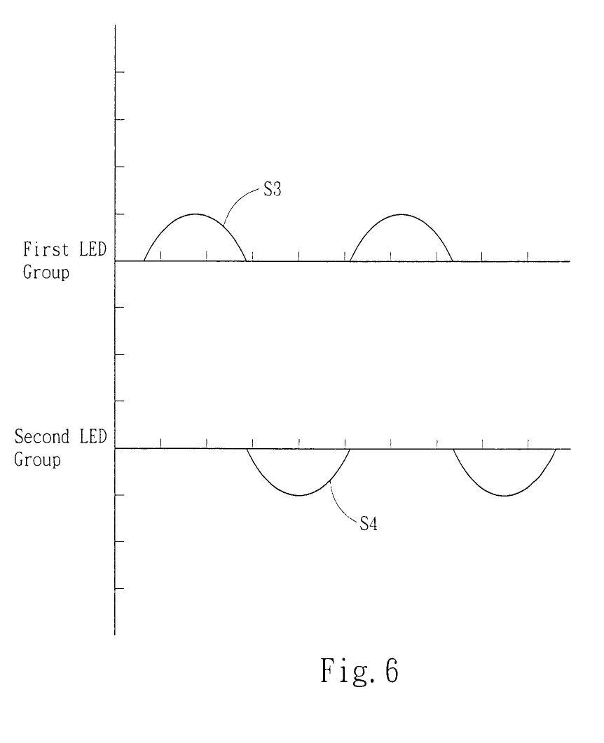

In a power modulation measure, an inverter 3 used for modulating the AC sine wave signal S1 of the AC obtaining measure according to the impedance of the first and second LED groups 1, 2 includes positive and negative half-cycle driving signals S2 (as shown in FIG. 5), and the driving signal S2 includes a positive half-cycle driving signal S3 complying with an operation range of the first LED group 1 and a negative half-cycle driving signal S4 complying with an operation range of the second LED group 2 (as shown in FIG. 6).

The inverter 3 can be a piezoelectric inverter or a coil inverter, wherein the inverter is preferably the piezoelectric inverter, since an auto load function of the piezoelectric inverter can modulate the inputted AC sine wave signal S1 and the driving signal S2 according to a total impedance of the first and second LED groups 1, 2, such that the positive and negative half-cycle driving signals S3, S4 allocated by each LED 10, 20 in the first and second LED groups 1, 2 comply with their operation range, and thus preventing damages to LEDs caused when driving the AC as frequently occurred in prior arts. Regardless of the operation range and quantity of LEDs 10, 20, an auto load function of a power modulation provides manufacturers a flexible way of changing components or circuits in the circuit design. Further, the piezoelectric inverter can suppress surges or electromagnetic interferences.

In the power driving measure, the positive half-cycle driving signal S3 of the power modulation measure drives the first LED group 1, and uses a negative half-cycle driving signal S4 to drive the second LED group 2, wherein the first and second LED groups 1, 2 are driven according to the sequential operating cycles of the positive and negative half-cycle driving signals S3, S4. In the invention, the LEDs 10, 20 in the first and second LED groups 1, 2 will not be lit continuously to accumulate heat for a long time, so as to prevent any damage or accident caused by a high temperature of the lit LEDs 10, 20.

The method of the invention further comprises a signal modulating measure taken after the power modulation measure, and the signal modulating measure sets an operating cycle of the driving signal S2 to modulate sequential operating cycles of the positive and negative half-cycle driving signals S3, S4, and the sequential operating cycles of the positive and negative half-cycle driving signals S3, S4 are set according to the actual application of the products. For instance, if the present invention applies an LCD screen of an electronic product that requires frequent viewings by human eyes, the sequential operating cycles must take the blinking light acceptable by human eyes into consideration, and the frequencies produced by the sequential operating cycles of the positive and negative half-cycle driving signals S3, S4 must be greater than 60 Hz. The higher the operating frequency, the less is the affection of a blinking condition to human eyes, and thus the aforementioned signal modulating measure can be taken to control the frequency to fit the level acceptable to human eyes, and avoiding an idle status of an inverter 3. If the invention is applied to a neon light signboard, the signal modulating measure can be used to set the frequencies of sequential operating cycles of the positive and negative half-cycle driving signals S3, S4 to less than 60 Hz, such that the first and second LED groups 1, 2 in the neon light signboard are lit alternately.

While the invention has been described by means of specific embodiments, numerous modifications and variations could be made thereto by those skilled in the art without departing from the scope and spirit of the invention set forth in the claims.

What is claimed is:

1. A method for driving an alternate current of a light emitting diode, comprising:
an AC obtaining measure, for obtaining an AC sine wave signal having positive and negative half-cycle waveforms;
a power modulation measure, for modulating an impedance of the first and second LED groups according to at least two conducting directions that are in opposite directions with each other and connected in parallel and an AC sine wave signal of the AC obtaining measure to change the positive half-cycle waveform of the AC sine wave signal to comply with an operation range of the positive half-cycle driving signal of the first LED group, and the negative half-cycle waveform of the AC sine wave signal to comply with an operation range of the negative half-cycle driving signal of the second LED group; and
a power driving measure, for driving the first LED group by the positive half-cycle driving signal of the power modulation measure and driving the second LED group by the negative half-cycle driving signal, wherein the first and second LED groups are driven sequentially according to operating cycles of the positive and negative half-cycle driving signals.

2. The method for driving the alternate current of the light emitting diode as recited in claim 1, wherein each LED group includes a plurality of LEDs connected in series and having a same conducting direction.

3. The method for driving the alternate current of the light emitting diode as recited in claim 2, wherein all LEDs in the first LED group has a conducting direction opposite to that of all LEDs in the second LED group.

4. The method for driving the alternate current of the light emitting diode as recited in claim 1, wherein the power modulation measure is achieved by using an inverter to detect an impedance of first and second LED groups and automatically modulate the AC modulated sine wave signal.

5. The method for driving the alternate current of the light emitting diode as recited in claim 4, wherein the inverter is a piezoelectric inverter.

6. The method for driving the alternate current of the light emitting diode as recited in claim 4, wherein the inverter is a coil inverter.

7. The method for driving the alternate current of the light emitting diode as recited in claim 1, further comprising a signal modulating measure taken after the power modulation measure, and the signal modulating measure is provided for modulating operating cycles of the positive and negative half-cycle driving signals.
